(19) United States
(12) Patent Application Publication
(10) Pub. No.: US 2024/0337860 A1
(43) Pub. Date: Oct. 10, 2024

(54) OPTICAL ELEMENT DRIVING MECHANISM

(71) Applicant: TDK TAIWAN CORP., Taoyuan City (TW)

(72) Inventors: Ying-Jen WANG, Taoyuan City (TW); Ya-Hsiu WU, Taoyuan City (TW)

(21) Appl. No.: 18/627,999

(22) Filed: Apr. 5, 2024

Related U.S. Application Data
(60) Provisional application No. 63/457,894, filed on Apr. 7, 2023.

(51) Int. Cl. G02B 27/64; G02B 7/02

(52) U.S. Cl. CPC G02B 27/646; G02B 7/02

(57) ABSTRACT

An optical element driving mechanism is provided, which includes a first movable portion, a fixed portion, and a first driving assembly. The first movable portion is used for connecting to a first optical module having an optical axis. The first movable portion is movable relative to the fixed portion. The first driving assembly is used for driving the first movable portion to move relative to the fixed portion.

### CROSS REFERENCE TO RELATED APPLICATIONS

This application claims priority of U.S. Provisional Application No. 63/457,894, filed on Apr. 7, 2023, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include an optical system to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided in some embodiments of the present disclosure, which includes a first movable portion, a fixed portion, and a first driving assembly. The first movable portion is used for connecting to a first optical module having an optical axis. The first movable portion is movable relative to the fixed portion. The first driving assembly is used for driving the first movable portion to move relative to the fixed portion.

In some embodiments, the optical element driving mechanism further includes a first intermediate assembly, and the first movable portion is movable relative to the fixed portion through the first intermediate assembly, the first intermediate assembly includes a first intermediate element, a first pressing element used for generating a first stabilizing force to lean the first movable portion to the fixed portion, and a second pressing element used for generating a second stabilizing force to lean the first movable portion to the fixed portion.

In some embodiments, the first movable portion includes a first corresponding portion in contact with the first intermediate element. The first intermediate element is between the first pressing element and the second pressing element. The first intermediate element is movable relative to the first corresponding portion.

In some embodiments, the fixed portion is polygonal when viewed along a main axis, and the first intermediate element, the first pressing element, and the second pressing element are disposed on a first side of the fixed portion.

In some embodiments, the first intermediate element is strip-shaped and extending along the main axis. The first intermediate element includes a first surface, a second surface, and a third surface facing the first corresponding portion when viewed along the main axis. The first surface and the second surface are not parallel.

In some embodiments, the first surface has a flat structure and is in contact with the first corresponding portion. The second surface has a flat structure and is in contact with the first corresponding portion.

In some embodiments, a gap is formed between the first corresponding portion and the third surface. The third surface is between the first surface and the second surface. The third surface has a flat structure. The fixed portion includes a second corresponding portion in direct contact with the first intermediate element.

In some embodiments, the optical element driving mechanism further includes a second optical module and a connecting assembly. The fixed portion further includes a first frame and a bottom, and the second optical module connects to the bottom through the first frame. The first movable portion is in a first accommodating space of the bottom. The first frame connects to the bottom through the connecting assembly.

In some embodiments, the connecting assembly includes a first protruding portion, a first concave portion corresponding to the first protruding portion, a second protruding portion extending from the first protruding portion to the first concave portion, and a third protruding portion extending from the first concave portion to the first protruding portion.

In some embodiments, a width of the first concave portion is greater than a width of the second protruding portion for at least 0.05 mm in the direction perpendicular to the main axis.

In some embodiments, the optical element driving mechanism further includes a first connecting element, the first frame connects to the bottom through the first connecting element. The first connecting element is in direct contact with the first concave portion. The first connecting element is in direct contact with the first protruding portion.

In some embodiments, the first connecting element is in direct contact with the second protruding portion. The first connecting element is in direct contact with the third protruding portion.

In some embodiments, the first protruding portion is not in contact with a bottom portion of the first concave portion. The third protruding portion is not in contact with the first protruding portion.

In some embodiments, the first optical module and the second optical module are arranged along the main axis. The first protruding portion at least partially overlaps the first concave portion in the direction that the main axis extends.

In some embodiments, the first concave portion do not overlap the second optical module in the direction that the main axis extends.

In some embodiments, the optical element driving mechanism further includes a second movable portion used for connecting to the second optical module and being movable relative to the fixed portion, and a second driving assembly used for driving the second movable portion to move.

In some embodiments, the second movable portion is movable relative to the first movable portion. When the first movable portion is at a first limit position, the first movable portion is in direct contact with a first contact portion of the fixed portion. When the first movable portion is at a second limit position, the first movable portion is in direct contact with a second contact portion of the first frame. The first contact portion and the second contact portion do not overlap each other in the direction that the main axis extends.

In some embodiments, the fixed portion further includes a second frame, a second accommodating space is formed between the first frame and the second frame, and the second movable portion is at least partially in the second accommodating space. The second driving assembly is at least partially disposed in the second accommodating space.

In some embodiments, the first movable portion is not in the second accommodating space. The second movable portion is not in the first accommodating space.

In some embodiments, the fixed portion further includes a case, and a third accommodating space is formed between the case and the bottom. The second accommodating space is in the third accommodating space. The first accommodating space is in the third accommodating space. The first accommodating space is formed between the first frame and the bottom.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of an optical element driving mechanism.

FIG. 1B is an exploded view of the optical element driving mechanism.

FIG. 1C is a top view of the optical element driving mechanism.

FIG. 2A is a cross-sectional view illustrated along the line A-A in FIG. 1C.

FIG. 2B is an enlarged view of a region in FIG. 2A.

FIG. 3A and FIG. 3B are schematic views of some elements of the optical element driving mechanism.

FIG. 4A is a schematic view of some elements of the optical element driving mechanism.

FIG. 4B is an enlarged view of the region in FIG. 4A.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

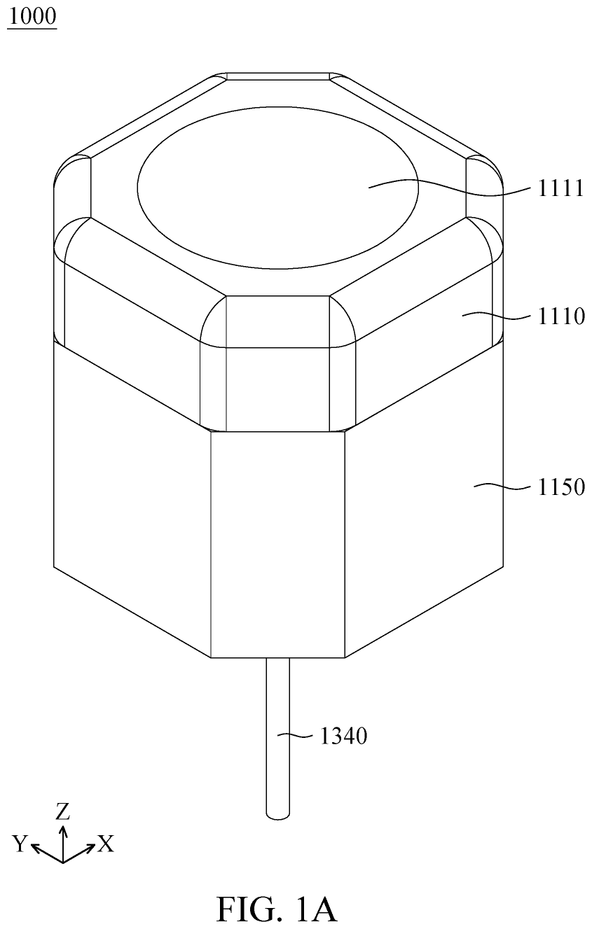

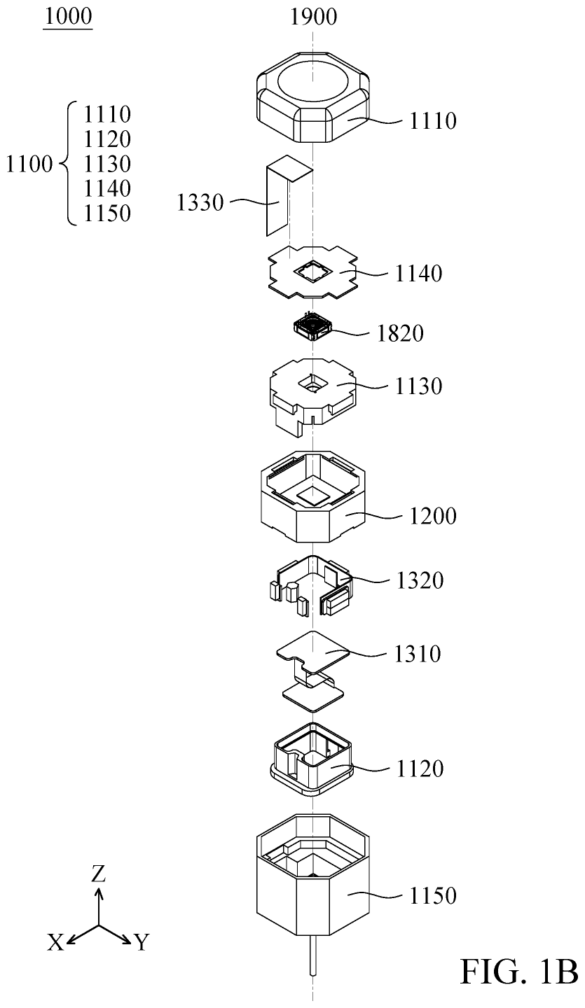

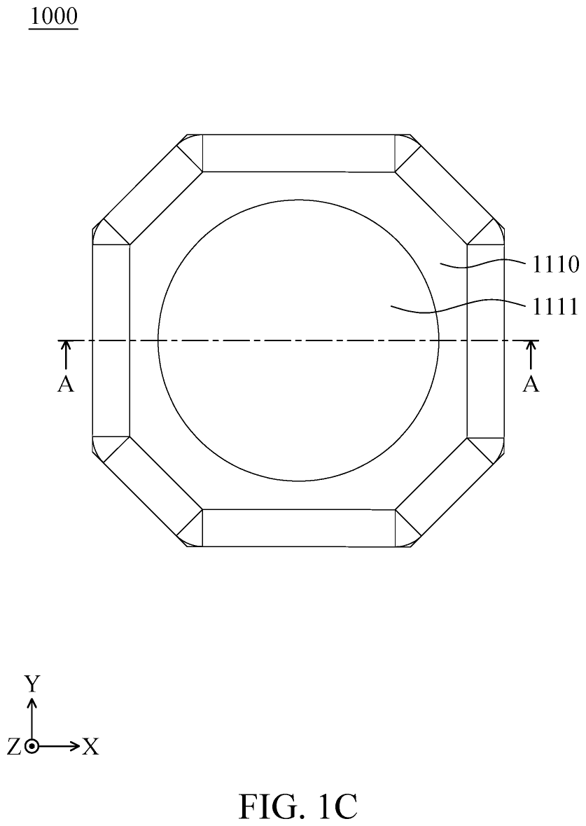

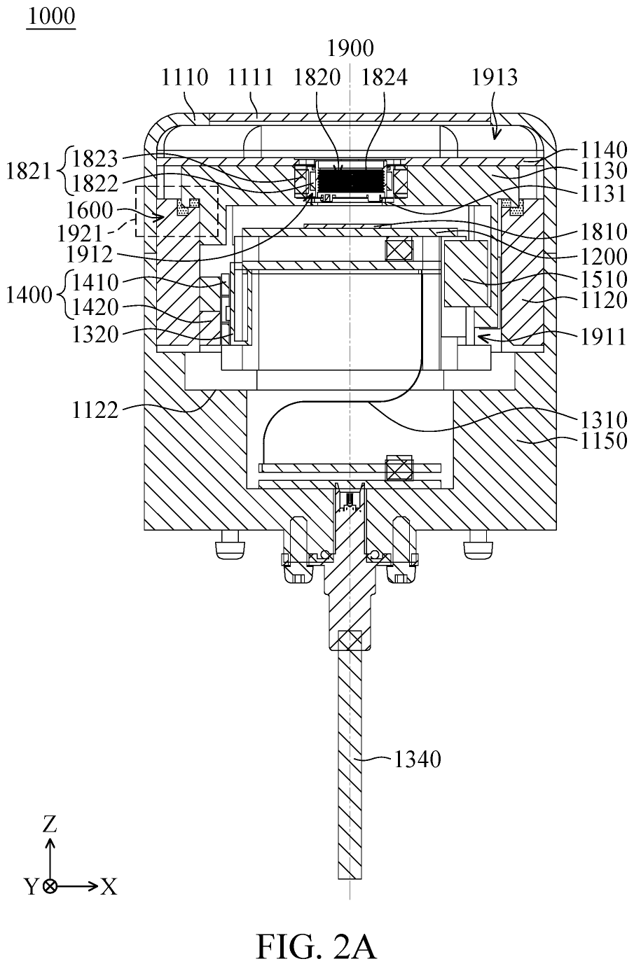

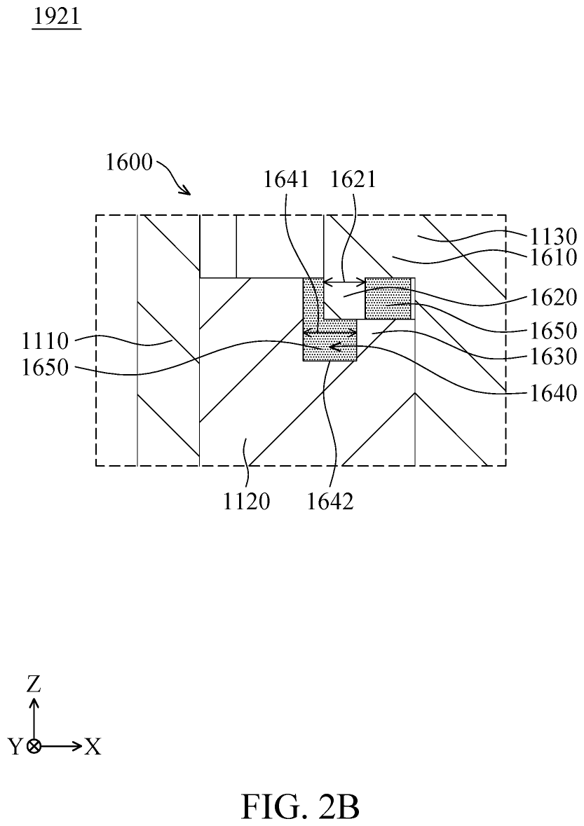

An optical element driving mechanism is provided in some embodiments of the present disclosure to drive an optical element to move. For example, FIG. 1A is a schematic view of an optical element driving mechanism 1000. FIG. 1B is an exploded view of the optical element driving mechanism 1000. FIG. 1C is a top view of the optical element driving mechanism 1000. FIG. 2A is a cross-sectional view illustrated along the line A-A in FIG. 1C.

As shown in FIG. 1A to FIG. 2A, the optical element driving mechanism 1000 may mainly include a fixed portion 1100 (which may include a case 1110, a bottom 1120, a first frame 1130, a second frame 1140, and a third frame 1150), a protecting element 1111, a first movable portion 1200, a first circuit element 1310, a second circuit element 1320, a third circuit element 1330, a first driving assembly 1400 (which may include a first driving coil 1410 and a first magnetic element 1420), a first intermediate element 1510, a first optical module 1810, and a second optical module 1820. These elements are arranged along a main axis 1900.

In some embodiments, the case 1110, the bottom 1120, the first frame 1130, the second frame 1140, and the third frame 1150 may be assembled and fixed with each other. For example, as shown in FIG. 2A, the case 1110 may be assembled with the third frame 1150, and the bottom 1120 and the first frame 1130 may be combined with each other and may be disposed in the case 1110 and the third frame 1150. The second frame 1140 may be disposed on the first frame 1130. In some embodiments, a first accommodating space 1911 may be formed between the bottom 1120 and the first frame 1130, a second accommodating space 1912 may be formed between the first frame 1130 and the second frame 1140, a third accommodating space 1913 may be formed between the case 1110 and the bottom 1120, and the first accommodating space 1911 and the second accommodating space 1912 may be in the third accommodating space 1913. Therefore, other elements of the optical element driving mechanism 1000 may be disposed in the accommodating spaces to protect these elements.

In some embodiments, the case 1110 may have an opening, and the protecting element 1111 may be disposed in the opening. The protecting element 1111 may include transparent material to allow external light entering the optical element driving mechanism 1000 through the opening on the case 1110, and dust may be prevented from entering the optical element driving mechanism 1000 to protect the optical element driving mechanism 1000.

In some embodiments, the first movable portion 1200 may be disposed in the first accommodating space 1911, may be movably connected to the fixed portion 1100, and may be used for connecting to the first optical module 1810. In some embodiments, the first optical module 1810 may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the first circuit element 1310 may be disposed between the fixed portion 1100 and the first movable portion 1200, such as disposed on the third frame 1150 and the first movable portion 1200 to electrically connect to the first optical module 1810 and external circuit. In some embodiments, the second circuit element 1320 may be disposed on the first movable portion 1200 and may be used for electrically connecting to the first driving assembly 1400 and external circuits. In some embodiments, the first circuit element 1310 and the second circuit element 1320 may include printed circuit board (PCB) or flexible printed circuit (FPC). In some embodiments, a conductive element 1340 may be disposed on the third frame 1150 and electrically connected to the first circuit element 1310 to allow external devices being electrically connected to the optical element driving mechanism 1000. In some embodiments, as shown in FIG. 2A, the second optical module 1820, the first optical module 1810, the first circuit element, and the conductive element 1340 may sequentially arrange along the main axis 1900.

In some embodiments, the first driving assembly 1400 may be disposed between the fixed portion 1100 and the first movable portion 1200 to drive the first movable portion 1200 moving relative to the fixed portion 1100. For example, the first movable portion 1200 may be driven to move relative to the fixed portion 1100 in a direction that is parallel to the main axis 1900, thereby achieving auto focus (AF) or zooming.

FIG. 2B is an enlarged view of a region 1921 in FIG. 2A. As shown in FIG. 2B, the connecting portions of the bottom 1120 and the first frame 1130 may be called as a connecting assembly 1600, and the connecting assembly 1600 may include a first protruding portion 1610, a second protruding portion 1620, a third protruding portion 1630, and a first concave portion 1640. The first protruding portion 1610 may be the portion of the first frame 1130 extending in the direction perpendicular to the Z axis in the region 1921. The second protruding portion 1620 may be the portion extending from the first protruding portion 1610 toward the first concave portion 1640, such as extending from the first protruding portion 1610 in the −Z direction. The third protruding portion 1630 may be the portion extending from the first concave portion 1640 toward the first protruding portion 1610. The first concave portion 1640 may correspond to the first protruding portion 1610, such as may be at least partially overlap each other in the direction that the Z axis extends.

In some embodiments, in the direction perpendicular to the main axis 1900, the width 1641 of the first concave portion 1640 may be greater than the width 1621 of the second protruding portion 1620, such as the width 1641 may be greater than the width 1621 for at least 0.05 mm. The first protruding portion 1610 does not in contact with the bottom portion 1642 of the first concave portion 1640, and the third protruding portion 1630 does not in contact with the first protruding portion 1610. In a direction that the main axis 1900 extends, the first protruding portion 1610 and the first concave portion 1640 at least partially overlap each other to make sure enough spaces is at the connecting position between the bottom 1120 and the first frame 1130 (adjacent to the connecting assembly 1600). A first connecting element 1650 may be disposed in this space, so the first frame 1130 may connect to the bottom 1120 through the first connecting element 1650. In some embodiments, the first connecting element 1650 may be in direct contact with the first protruding portion 1610, the second protruding portion 1620, the third protruding portion 1630, and the first concave portion 1640, and may include adhesive materials such as thermosetting adhesive or light-setting adhesive. Therefore, the contact area of the first connecting element 1650 to the bottom 1120 and the first frame 1130 may be increased to fix the bottom 1120 and the first frame 1130.

In some embodiments, the second optical module 1820 may be disposed on the first frame 1130 and may connect to the bottom 1120 through the first frame 1130. In some embodiments, as shown in FIG. 2A and FIG. 2B, in the direction that the main axis 1900 extends, the connecting assembly 1600 (e.g. the first concave portion 1640) does not overlap the second optical module 1820. In some embodiments, the second optical module 1820 may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the optical element driving mechanism 1000 may further include a second driving assembly 1821 (which includes a second driving coil 1822 and a second magnetic element 1823) and a second movable portion 1824. The second optical module 1820 may be disposed on the second movable portion 1824, and the second movable portion 1824 may be at least partially disposed in the second accommodating space 1912 and movably connected to the first frame 1130. In other words, the second movable portion 1824 is movable relative to the fixed portion 1100.

The second driving assembly 1821 may be disposed between the second movable portion 1824 and the first frame 1130, such as at least partially disposed in the second accommodating space 1912 to drive the second movable portion 1824 moving relative to the fixed portion 1100. For example, the second driving coil 1822 may be disposed on the second movable portion 1824 and the second magnetic element 1823 may be disposed on the first frame 1130, or their positions may be interchanged to generate an electromagnetic force for moving the second movable portion 1824 relative to the fixed portion 1100. In some embodiments, the first movable portion 1200 and the second movable portion 1824 may move relative to each other, thereby the first optical module 1810 and the second optical module 1820 may also move relative to each other to achieve auto focus or zooming. In some embodiments, the third circuit element 1330 may be used for electrically connect to the second driving assembly 1821 and external circuits. In some embodiments, the first optical module 1810 and the second optical module 1820 may have different movable stroke (maximum movable range) in the direction that the main axis 1900 extends, such as the movable stroke of the first optical module 1810 may be greater than the movable stroke of the second optical module 1820, thereby achieving higher freedom of zooming.

In some embodiments, when the first movable portion 1200 moves relative to the fixed portion 1100 to reach a first limit position (such as moves in the −Z direction to a maximum movable position), the first movable portion 1200 may be in direct contact with a first contact portion 1122 of the third frame 1150 at this moment. When the first movable portion 1200 moves relative to the fixed portion 1100 to reach a second limit position (such as moves in the +Z direction to a maximum movable position), the first movable portion 1200 may be in direct contact with a second contact portion 1131 of the second pressing element 1530 at this moment. Therefore, the maximum movable range of the first movable portion 1200 may be defined. In some embodiments, the first contact portion 1122 and the second contact portion 1131 do not overlap each other in the direction that the main axis 1900 extends to reduce the size in this direction, thereby achieving miniaturization. In some embodiments, the first movable portion 1200 is not in the second accommodating space 1912, and the second movable portion 1824 is not in the first accommodating space 1911 to prevent collision when they are moving.

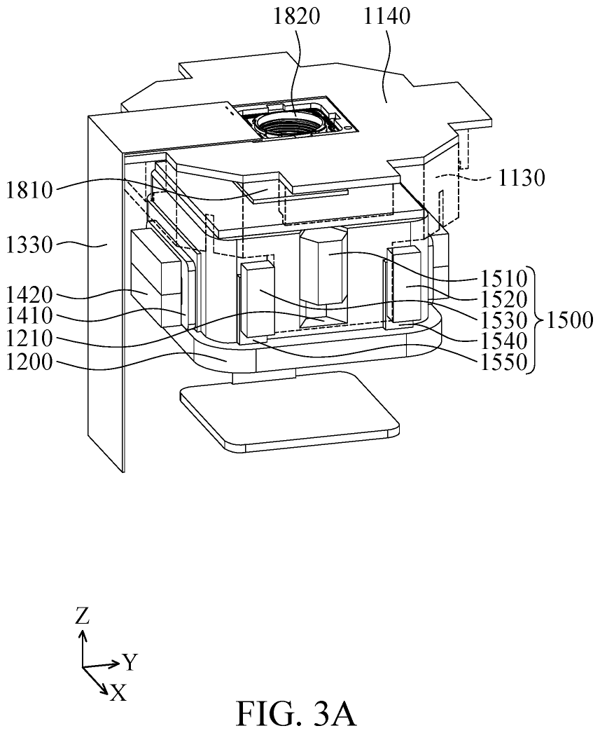

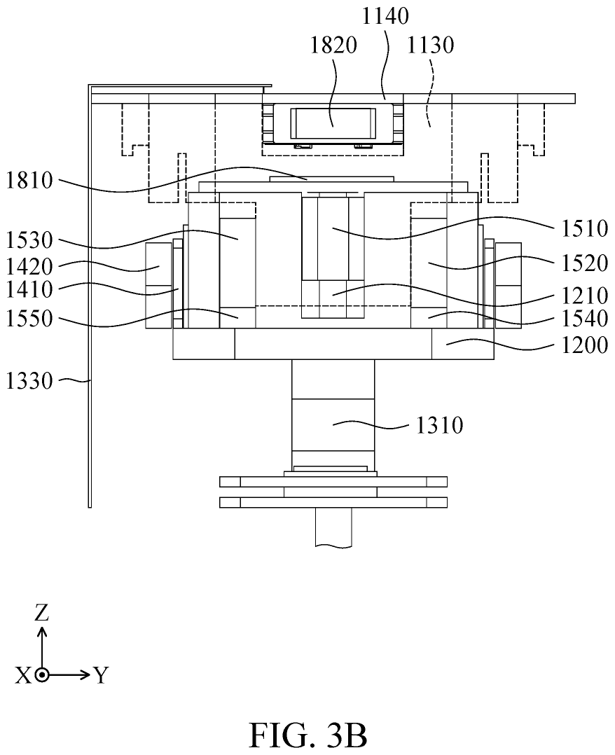

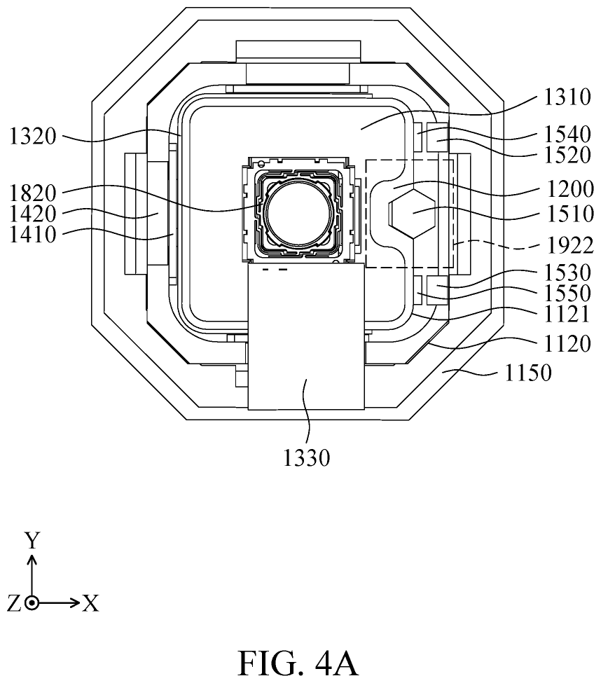

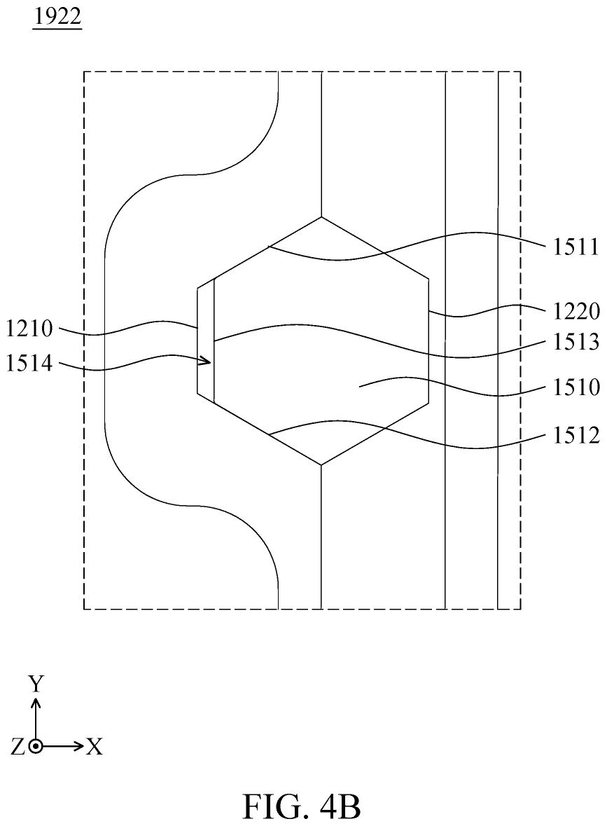

FIG. 3A and FIG. 3B are schematic views of some elements of the optical element driving mechanism 1000. FIG. 4A is a schematic view of some elements of the optical element driving mechanism 1000. As shown in FIG. 3A, FIG. 3B, and FIG. 4A, a first intermediate assembly 1500 may be disposed between the first movable portion 1200 and the fixed portion 1100 to allow the first movable portion 1200 move relative to the fixed portion 1100. In some embodiments, the first intermediate assembly 1500 may include a first intermediate element 1510, a first pressing element 1520, a second pressing element 1530, a first corresponding element 1540, and a second corresponding element 1550.

The first intermediate element 1510 may be in direct contact with the first movable portion 1200 and the bottom 1120. FIG. 4B is an enlarged view of the region 1922 in FIG. 4A. As shown in FIG. 3A, FIG. 3B, and FIG. 4B, the first movable portion 1200 may include a first corresponding portion 1210, and the bottom 1120 may include a bottom 1120. The first corresponding portion 1210 and the second corresponding portion 1220 may be recesses. The first intermediate element 1510 may be strip-shaped and may be disposed in the first corresponding portion 1210 and the bottom 1120 and in contact with the first corresponding portion 1210 and the second corresponding portion 1220. In some embodiments, the first intermediate element 1510 may be affixed on the second corresponding portion 1220 and may move relative to the first corresponding portion 1210, such as disposed on the first corresponding portion 1210 by friction contact.

In some embodiments, when viewed along the main axis 1900, as shown in FIG. 4B, the first corresponding portion 1210 may include a first surface 1511, a second surface 1512, and a third surface 1513 facing the first intermediate element 1510. The first surface 1511, the second surface 1512, and the third surface 1513 may be not parallel to each other and may have flat structures. In some embodiments, the first surface 1511 and the second surface 1512 may be in direct contact with the first intermediate element 1510, and a gap 1514 may be between the third surface 1513 and the first intermediate element 1510. Therefore, when tolerances occur in the production of each elements, the first intermediate element 1510 can still be disposed in the first movable portion 1200.

In some embodiments, as shown in FIG. 3A, FIG. 3B, and FIG. 4A, the first pressing element 1520 and the second pressing element 1530 may be disposed on the bottom 1120, and the first corresponding element 1540 and the second corresponding element 1550 may be disposed on the first movable portion 1200. The first pressing element 1520 and the second pressing element 1530 may correspond to the first corresponding element 1540 and the second corresponding element 1550, respectively. For example, the first pressing element 1520 and the second pressing element 1530 may at least partially overlap the first corresponding element 1540 and the second corresponding element 1550 in the X axis when viewed along the main axis 1900, respectively.

In some embodiments, the first pressing element 1520 and the second pressing element 1530 may generate a first stabilizing force and a second stabilizing force with the first corresponding element 1540 and the second corresponding element 1550 to lean the first movable portion 1200 on the fixed portion 1100, respectively. For example, the first pressing element 1520 and the second pressing element 1530 may include magnets, and the first corresponding element 1540 and the second corresponding element 1550 may include magnetic elements. Therefore, attraction forces may be generated between the first pressing element 1520, the second pressing element 1530, the first corresponding element 1540 and the second corresponding element 1550 to lean the first movable portion 1200 to the fixed portion 1100.

In some embodiments, as shown in FIG. 3A, FIG. 3B, and FIG. 4A, the first intermediate element 1510 may be disposed between the first pressing element 1520 and the second pressing element 1530. The first intermediate element 1510, the first pressing element 1520, and the second pressing element 1530 may be disposed on the first side 1121 of the bottom 1120. Moreover, as shown in FIG. 4A, the first magnetic element 1420 and the first driving coil 1410 may be disposed on a side of the fixed portion 1100 different from the side that the first pressing element 1520, the second pressing element 1530, the first corresponding element 1540, and the second corresponding element 1550 disposed on to prevent from magnetic interference.

In summary, an optical element driving mechanism is provided, which includes a first movable portion, a fixed portion, and a first driving assembly. The first movable portion is used for connecting to a first optical module having an optical axis. The first movable portion is movable relative to the fixed portion. The first driving assembly is used for driving the first movable portion to move relative to the fixed portion. Therefore, auto focus may be performed, the position of the movable portion may be stabilized, and miniaturization may be achieved.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a first movable portion used for connecting a first optical module;
a fixed portion, wherein the first movable portion is movable relative to the fixed portion; and
a first driving assembly used for driving the first movable portion to move relative to the fixed portion.

2. The optical element driving mechanism as claimed in claim 1, further comprising a first intermediate assembly, and the first movable portion is movable relative to the fixed portion through the first intermediate assembly, wherein:
the first intermediate assembly comprises:
a first intermediate element;
a first pressing element used for generating a first stabilizing force to lean the first movable portion to the fixed portion; and
a second pressing element used for generating a second stabilizing force to lean the first movable portion to the fixed portion.

3. The optical element driving mechanism as claimed in claim 2, wherein:
the first movable portion comprises a first corresponding portion in contact with the first intermediate element;
the first intermediate element is between the first pressing element and the second pressing element;
the first intermediate element is movable relative to the first corresponding portion.

4. The optical element driving mechanism as claimed in claim 3, wherein the fixed portion is polygonal when viewed along a main axis, and the first intermediate element, the first pressing element, and the second pressing element are disposed on a first side of the fixed portion.

5. The optical element driving mechanism as claimed in claim 4, wherein:
the first intermediate element is strip-shaped and extending along the main axis;
the first intermediate element comprises a first surface, a second surface, and a third surface facing the first corresponding portion when viewed along the main axis;
the first surface and the second surface are not parallel.

6. The optical element driving mechanism as claimed in claim 5, wherein:
the first surface has a flat structure and is in contact with the first corresponding portion;
the second surface has a flat structure and is in contact with the first corresponding portion.

7. The optical element driving mechanism as claimed in claim 6, wherein:
a gap is formed between the first corresponding portion and the third surface;
the third surface is between the first surface and the second surface;
the third surface has a flat structure;
the fixed portion comprises a second corresponding portion in direct contact with the first intermediate element.

8. The optical element driving mechanism as claimed in claim 7, further comprising a second optical module and a connecting assembly, wherein:
the fixed portion further comprises a first frame, a second frame, a bottom, and a case, and the second optical module connects to the bottom through the first frame;
a first accommodating space is formed between the first frame and the bottom;
the first movable portion is in the first accommodating space;
the first frame connects to the bottom through the connecting assembly;
a second accommodating space is formed between the first frame and the second frame;
the first movable portion is not in the second accommodating space;
a third accommodating space is formed between the case and the bottom;
the first accommodating space is in the third accommodating space;
the second accommodating space is in the third accommodating space.

9. The optical element driving mechanism as claimed in claim 8, wherein the connecting assembly comprises:
a first protruding portion;
a first concave portion corresponding to the first protruding portion;
a second protruding portion extending from the first protruding portion to the first concave portion; and
a third protruding portion extending from the first concave portion to the first protruding portion.

10. The optical element driving mechanism as claimed in claim 9, wherein a width of the first concave portion is greater than a width of the second protruding portion for at least 0.05 mm in the direction perpendicular to the main axis.

11. The optical element driving mechanism as claimed in claim 10, further comprising a first connecting element, wherein:
the first frame connects to the bottom through the first connecting element;
the first connecting element is in direct contact with the first concave portion;
the first connecting element is in direct contact with the first protruding portion.

12. The optical element driving mechanism as claimed in claim 11, wherein:
the first connecting element is in direct contact with the second protruding portion;
the first connecting element is in direct contact with the third protruding portion.

13. The optical element driving mechanism as claimed in claim 12, wherein:
the first protruding portion is not in contact with a bottom portion of the first concave portion;
the third protruding portion is not in contact with the first protruding portion.

14. The optical element driving mechanism as claimed in claim 13, wherein:
the first optical module and the second optical module are arranged along the main axis;
the first protruding portion at least partially overlaps the first concave portion in the direction that the main axis extends.

15. The optical element driving mechanism as claimed in claim 14, wherein the first concave portion do not overlap the second optical module in the direction that the main axis extends.

16. The optical element driving mechanism as claimed in claim 15, further comprising:
a second movable portion used for connecting to the second optical module and being movable relative to the fixed portion; and
a second driving assembly used for driving the second movable portion to move.

17. The optical element driving mechanism as claimed in claim 16, wherein:
the second movable portion is movable relative to the first movable portion;
when the first movable portion is at a first limit position, the first movable portion is in direct contact with a first contact portion of the fixed portion;
when the first movable portion is at a second limit position, the first movable portion is in direct contact with a second contact portion of the first frame.

18. The optical element driving mechanism as claimed in claim 17, wherein:
the second movable portion is not in the first accommodating space;
the second movable portion is at least partially in the second accommodating space;
the second driving assembly is at least partially disposed in the second accommodating space;
the first contact portion and the second contact portion do not overlap each other in the direction that the main axis extends.

19. The optical element driving mechanism as claimed in claim 18, wherein maximum stroke of the first optical module is greater than maximum stroke of the second optical module in the direction that the main axis extends.

20. The optical element driving mechanism as claimed in claim 19, wherein the second optical module, the first optical module, the first circuit element, and the conductive element sequentially arrange along the main axis.
